(19) United States
(12) Patent Application Publication
(10) Pub. No.: US 2008/0225044 A1
(43) Pub. Date: Sep. 18, 2008

(54) Method and Apparatus for Editing Three-Dimensional Images

(75) Inventors: Su Huang, Singapore (SG); Wieslaw Lucjian Nowinski, Singapore (SG); Mikalai Ivanou, Singapore (SG); Aamer Aziz, Singapore (SG)

Correspondence Address: NIXON PEABODY, LLP, 401 9TH STREET, NW, SUITE 900, WASHINGTON, DC, 20004-2128, US

(73) Assignee: AGENCY FOR SCIENCE, TECHNOLOGY AND RESEARCH, Singapore (SG)

(21) Appl. No.: 11/884,464

(22) PCT Filed: Feb. 17, 2005
(86) PCT No.: PCT/SG05/00045

§ 371 Date: Aug. 16, 2007

(51) Int. Cl. G06T 17/00

(52) U.S. Cl. 345/420

(57) ABSTRACT

A method for editing three dimensional images comprises the steps of obtaining three dimensional data representative of an image (2), segmenting the data to select data to be processed (3), generating a three dimensional model of the selected data (6) and interpolating the three dimensional model of the selected data to generate a continuous three dimensional model (8). One or more tri-planar contours are then extracted from the continuous three dimensional model (10) and the continuous three dimensional model may then be edited. A three dimensional surface model is then generated from the one or more extracted tri-planar contours. The three dimensional surface model may also be edited (12).

### FIELD OF THE INVENTION

The present invention relates to a method and apparatus for editing three dimensional images.

### BACKGROUND OF THE INVENTION

The objective of radiological diagnostic techniques is to identify normal structures and pathological structures from medical radiology images. Radiology is becoming increasingly important in medical examination and diagnosis. Many patients have to undergo some form of radiological examination during the course of their treatment. With the advancement in technology, newer and more robust radiological technologies have become available. The greatest revolution has been with the advent of cross-sectional imaging and 3D volume imaging is a further refinement of that technique.

In order to define the pathologies in images, it is essential that normal structures and their normal variation should be clearly defined and illustrated. For this reason, a thorough knowledge of normal and anomalous anatomy is essential. The anatomical structures must be segmented and labelled in the form of atlases.

On 2D images this is a straightforward process and several software packages are available that satisfactorily perform this process. Such software is in extensive use in radiology. However, the techniques and the results of 2D processing cannot be used for 3D processing for a number of reasons. Firstly, to process an image one slice at a time is tedious if user intervention is required, and secondly, the results from 2D processing are not consistent in 3D.

As the body is a three dimensional object and all the organs occupy a volume, it is desirable to be able to visualize and edit the interested structures in radiological images in three dimensions as well as in two dimensions. The difficulties in segmentation and editing of structures in 3D images have hampered the full use and potential of three-dimensional (3D) medical imaging. As medical imaging in 3D volume is increasing in technology, the support software to edit 3D structures in image volumes is lagging behind and the software and tools which are currently in use are inadequate. These tools still do not deliver the desired 3D volume segmentation of anatomic structures with high fidelity.

At present, a user is generally forced to use manual or interactive methods to process the 3D data, slice by slice, in 3D. Some software does allow editing of volume data but such software is greatly dependent on tedious user manipulation.

Some of the commonly used software for 3D volume editing is described below:

### 3D-DOCTOR by Able Software Corp.

The main modules developed for the editing of images are Image Editor, Boundary Editor and Point Editor, the main functionalities of which are:

Image Editor—Image pixel values can be displayed in real time on a screen. A user can also modify pixel values by drawing in the image with a specified pen, and map pixel values to new ones.

Boundary Editor—Object boundaries generated from segmentation can be edited using this editor. A user can delineate an object boundary or region of interest manually with the boundary line editor. Boundary lines are used directly in 3D surface rendering and volume rendering.

Point Editor—Points of 3D locations can be marked using this editor. The locations can then be used on another image to show the difference of certain locations.

VTrace/Slice Align/Surfer by VayTek Inc. IA, US

VTrace—This is a general purpose, Region-based, 2D image analysis and 2D image measurement program. It creates regions of interest and outputs statistics based on those regions of interest. The statistics include region of interest (ROI) statistics and pixel statistics. ROI statistics include area, perimeter, length, major/minor axes, xy position, centroid and histogram. Pixel statistics include mean, standard deviation, maximum, minimum, running sum, etc. VTrace has a palette editor and allows for spatial and intensity calibration of a 2D image. It also allows the user to crop and cut to the ROI, then save the cropped images. This lets the user fill an ROI, and save a series of cropped or filled ROIs to create subvolumes. It also has a tracing editor and allows for autotracing of the images. VTrace reads and writes 8 bit or 16 bit raw images. It also reads and writes the TIFF image format, and the SGI image library format.

Slice Align—This is software to align and register a stack of 2D images. It consists of two programs: the first program lets a user align a stack of 2D images so they can be used in 3D reconstruction or deconvolution. The user identifies fiduciary points on two consecutive images, then aligns the two images to those selected points. After all the images are aligned, the second program loads all the images into memory and computes the final adjustments automatically using a least squares approach. These programs currently run on SGI and IBM computers.

Surfer—This is a 3D surface extraction for 3D rendering program. This program is most often used in combination with the Slice Align programs outlined above. Re-registered images sometimes do not render well due to the odd alignments of the boundaries on reregistered images. Surfer lets the user outline (by tracing) the areas of interest in each 2D image. After all the areas have been traced, Surfer extracts a surface, based on the multiple 2D traces. The extracted surface can be rendered in VoxBlast. Surfer is currently available on SGI machines.

The above software systems are just an example of the currently available state of technology. Although these software and tools are robust and useful, they still the lack the essential element of three-dimensional image editing and semi-automated segmentation.

In addition to these commercially available tools, there have been several attempts at 3D volume images.

Serra et al. proposed “Brain Bench” as virtual tools for stereotactic frame neurosurgery [Serra L, Nowinski W L, Poston T, Ng H, Lee C M, Chua G G and Pillay P K, The Brain Bench: virtual tools for stereotactic frame neurosurgery. Medical Image Analysis, 1997; 1(4):317-329]. They extracted vasculature by using 3D intervention with the volumetric data in the virtual environment. This solution is quite expensive, requiring dedicated tracking hardware, an expensive graphics workstation and a sophisticated software system.

In addition, Chui et al. [C K Chui, W Hua, Y P Wang and W L Nowinski, A novel approach for extracting and editing 3D Object associated with volume images using an interactive multimedia environment, Patent Pending. PCT filed—PCT & SG Filed: PCT/SG00/00101 & SG200300588-1, 7 Jul. 2000; published international application No: WO02/05217] proposed a solution to extract and edit a 3D object associated with volume images, using an interactive multimedia environment.

In the paper by Hua W, Chui C K, Wang Y, Wang Z, Chen X, Peng Q, Nowinski W L, entitled ‘A semiautomatic framework for vasculature extraction from volume image’, Proceedings of 10th International conference on biomedical engineering, December 2000, pp. 515-516, Hua et al. described the integrated visualization and image editing system to extract vasculature from 3D image scans. In this system, a volume rendered image is displayed in a virtual space, and a 6-DOF reach-in device is used to interact with the virtual volume. The position and orientation of the device is captured to trace and extract the interested object from the original volume data. In such a scheme, 2D contours were extracted and were used to generate an initial model of vasculature. Expensive graphical cards and a 3D tracking device were also required to carry out the volume visualization and object extraction.

Rusinek et al. [Rusinek H, Mourino M., Interactive graphic editor for analysis and enhancement of medical images. Comput Biomed Res 1989 August; 22(4):328-38] designed an interactive editor for analysis and enhancement of medical images. This software has been developed at the New York University Medical Center, NY, USA and defines subregions within a volume of medical images arranged in serial sections. The editing methods include tracing and automatic growing of connected components defined by the grey level range. The editor performs a statistical analysis of the signal contained in each subvolume and this is used in studies of magnetic resonance (MR) signals in medical images. The graphic editor is also used for creating 3D views from MR images based on a volume-rendering algorithm. The editor transforms the volume of images by remapping their grey levels and by multiplanar cuts.

Most of the previously available commercial software or research protocols have some drawbacks which make them tedious to work with or they do not provide enough tools to adequately segment the radiological images. The software available as standard operating systems with most commercial MRI machines is powerful enough to manipulate images, but it has limited tools to offer when segmenting 3D volume data.

Other software such as that described above is also limited in the 3D volume editing. Most of the editors solve these problems through 2D editing, but this requires extensive input from the user and will become inconsistent in 3D. Although some direct 3D editing solutions have been proposed, they often require expensive 3D tracking and rendering hardware.

Thus there is a need for a true three dimensional model editor which can segment the anatomical structures with minimal user interaction.

### SUMMARY OF THE INVENTION

In general terms, the invention provides a method for defining and editing and/or modifying the shape of 3D structures in images. Preferred embodiments allow for 3D editing using 2D interaction and manipulation on orthogonal planes. The proposed method has particular importance in the fields of interactive segmentation, labelling, quantification, 3D modelling and 3D model construction.

Users may extract the object of interest in many ways. Consequently, a 3D continuous model may be built and three orthogonal planes (tri-planar) contours may be extracted at any point confined by the object region. The shape of the object may be modified freely through modifying these tri-planar contours. As the editing is applied to a 3D continuous model, the consistencies of the modifications may be maintained. A 3D surface model may be generated from the tri-planar contours to extend the result to more applications. A spatial vertex index method may be designed to easily and efficiently manipulate the shape surface model.

Preferably, an algorithm embodying an aspect of the invention will enable easy and accurate 3D editing of volumetric data in a user friendly interface. The algorithm preferably enables 3D editing to be performed on both the image model and the surface model of, for example, anatomy shapes on radiological workstations, surgical workstations, scanner console, and standard personal computers.

Furthermore, embodiments of the invention provide a low cost solution which may be installed, for example, on a scanner console, a radiological workstation, a surgical workstation, a common desktop PC or electronic notebooks.

Also, preferred embodiments of the invention enable editing of multi-slice data concurrently and consistent editing of 3D data using 2D interaction and manipulation, and are simple to use.

Furthermore, embodiments of the invention may be applied to complicated 3D structures.

According to a first aspect of the invention there is provided a method for editing three dimensional images, the method comprising the steps of:
obtaining three dimensional data representative of an image;
segmenting the data to select data to be processed;
generating a three dimensional model of the selected data;
interpolating the three dimensional model of the selected data to generate a continuous three dimensional model;
extracting one or more tri-planar contours from the continuous three dimensional model;
editing the continuous three dimensional model;
generating a three dimensional surface model from the one or more extracted tri-planar contours; and
editing the three dimensional surface model.

According to a second aspect of the invention there is provided an apparatus for editing three dimensional images comprised of three dimensional image data, the apparatus comprising:
a selector for segmenting the data to select data to be processed;
a first generator for generating a three dimensional model of the selected data;
an interpolator for interpolating the three dimensional model of the selected data to generate a continuous three dimensional model;
an extractor for extracting one or more tri-planar contours from the continuous three dimensional model;
a first editor for editing the continuous three dimensional model;
a second generator for generating a three dimensional surface model from the one or more extracted tri-planar contours; and
a second editor for editing the three dimensional surface model.

According to a third aspect of the invention there is provided a computer program product comprising:
a computer usable medium having a computer readable code and computer readable system code embodied on said medium for editing three dimensional images; said computer program product further comprising:
computer readable code within said computer usable medium for:
obtaining three dimensional data representative of an image;
segmenting the data to select data to be processed;
generating a three dimensional model of the selected data;
interpolating the three dimensional model of the selected data to generate a continuous three dimensional model;
extracting one or more tri-planar contours from the continuous three dimensional model;
editing the continuous three dimensional model;
generating a three dimensional surface model from the one or more extracted tri-planar contours; and
editing the three dimensional surface model.

### BRIEF DESCRIPTION OF THE DRAWINGS

Preferred embodiments of the invention will now be described by way of example and with reference to the accompanying drawings in which:

FIG. 1 is a flow diagram showing the process steps in a method according to an embodiment of the invention;

FIG. 2 is a schematic block diagram showing a segmentation process;

FIG. 3 is a flow diagram showing the process steps in a method of 3D model generation according to an embodiment of the invention;

FIG. 4 is a representation of 3D iso-parametric interpolation;

FIG. 5 is a representation of contour extraction from a continuous field;

FIG. 6 is a flow diagram showing the process steps in a method for modifying a 3D model through tri-planar contour editing according to an embodiment of the invention;

FIG. 7a is a representation of a continuous contour model;

FIG. 7b is a representation showing the editing of the continuous contour model of FIG. 7a through shifting the grid points;

FIGS. 8a to 8h are a series of 3D editing stages of an object on three orthogonal 2D planes;

FIG. 9 is a representation of the object shape of a continuous contour model after contour editing;

FIG. 10 is a flow diagram of the process of surface modelling and editing according to an embodiment of the invention;

FIG. 11 is a diagram illustrating conventional triangle surface data storage and index; and

FIG. 12 is an illustration of a 2D polygon surface spatial indexing method.

### DETAILED DESCRIPTION OF PREFERRED EMBODIMENTS

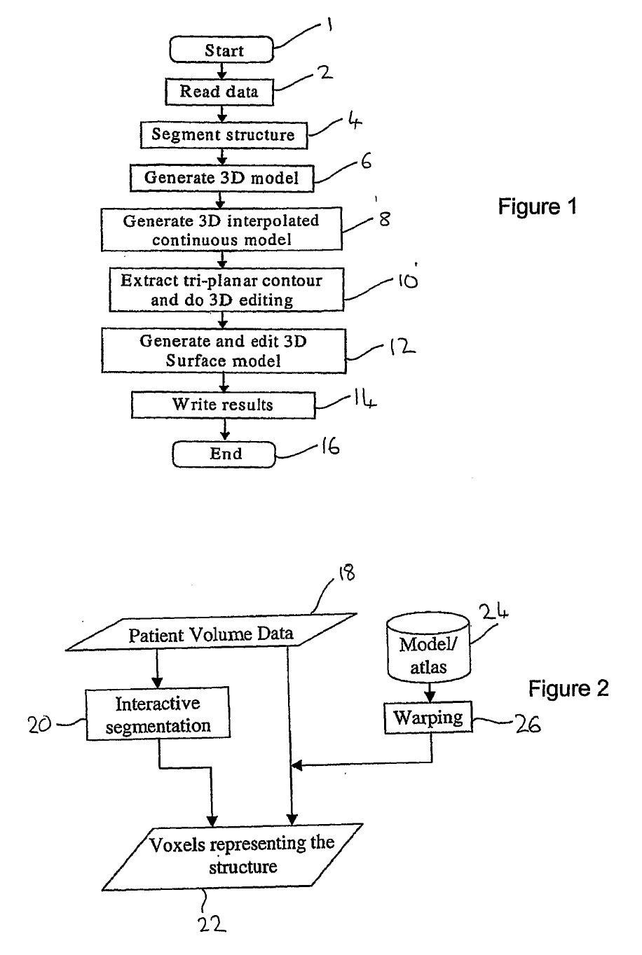

A flow diagram of the overall process according to an embodiment of the invention is shown in FIG. 1. The first stage 1 initiates the process and in stage 2 the data to be processed is read into the system. The data is then segmented in a further stage 4 to obtain a preliminary set of voxels. Taking these voxels as control points, the continuous approximation of a function, for example, the grey level, is generated as a 3D model in a fourth stage 6 and this is then interpolated in a fifth stage 8 to produce a 3D interpolated continuous model.

From the distribution of the interpolated smooth function, the tri-planar contours which are the contours of the interested shape on the orthogonal cross section planes (typically, the axial, coronal and sagittal planes), may be extracted in a sixth stage 10 and a surface model of the interested structure may be generated in a seventh stage 12. In this stage 12, the modification of the interested shape structure is performed by changing the 3D continuous model, monitored by the triplanar contour at any point.

The resulting output from the seventh stage 12 is a smooth representation of an anatomy or pathology structure, which may be used for example, for 3D surface/solid modelling, quantification and construction of a 3D model or atlas.

The data defining the surface is then written to a store in an eighth stage 14 to conclude the procedure in a ninth stage 16.

The main purpose of tri-planar editing is to segment a particular structure from the input patient data set. In a preferred embodiment, if a 3D model database/atlas is available, it may be used to guide the preliminary segmentation of the third stage 4 through warping. In this case, the structure to be processed is identified from the database/atlas, and is registered with the current patient data. Alternatively, if such a model is not available, the user may extract the region which corresponds to the structure. This may be achieved through interactive region growing, thresholding and other 2D contour editing.

The result of the above mentioned process is a set of voxels representing the object of interest. From this voxel set, in stage 8, a 3D ROI may be defined accordingly. Within this subspace, a continuous model of the object may be defined through interpolation.

In stage 10, a 3D tri-planar contour may be generated in every slice of the axial, sagittal and coronal directions. In this stage 10, the user may modify the 3D continuous structure through changing the tri-planar contours in any direction with respect to the patient data, refining the structure anatomy as many times as required until the operator is satisfied. As long as the 3D contours represent the structure in the patient data accurately, the result will be saved for further processing, which might include quantification, shape analysis, intervention planning, model/atlas construction and the like.

After the triplanar contours of the image model are extracted, the user may construct a surface model in stage 12, and edit the surface model interactively and efficiently with the support of surface vertex spatial indexing technology. This enables the final surface model of the ROI to be obtained.

Thus, the tedious 3D segmentation and editing which is present in prior art systems may be simplified in the present invention to 2D manipulations, eventually producing a segmentation result in 3D image models and surface models.

FIG. 2 shows the segmentation stage 4 (of FIG. 1) of the object of interest. Segmentation may be achieved in two ways, namely through interactive segmentation or through atlas warping. For interactive segmentation, the user may segment the object using any automatic, semiautomatic or interactive algorithm to obtain the 3D region corresponding to the object. This may be achieved through 2D/3D image processing tools. Patient data 18 is segmented, as described above, in the interactive segmentation stage 20. The resulting voxels are then stored 22 ready for the next processing stage. In the alternative approach where a model or atlas 24 is available, the object selected from the 3D model or atlas 24 is warped in a warping stage 26 to match it approximately with the current dataset from the patient volume data.

The space occupied by the transformed model is defined as the preliminary structure. The output 22 of the segmentation is the set of voxels representing the object under investigation.

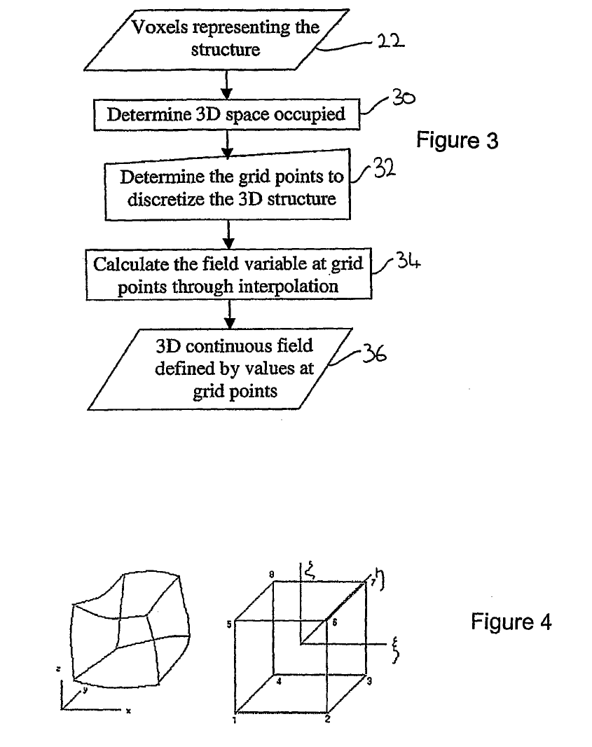

FIG. 3 shows the 3D generation of a 3D continuous model from the voxel sets 22 obtained in the segmentation stage of FIG. 2.

When the voxels 22 of the structure are taken as the input, by assigning a field value of, for example, 1.0 at its location and 0.0 for a vacant region, that is, a region consisting of voxels not in the shape under consideration, a continuous field for the space in which the object is located may be determined in a second stage 30. This may be achieved by computing the spatial position of the voxels in the object multiplied by the dimension of the voxels. In the next stage 32, grid points are determined to discretize the structure. Initially the grid may be constructed as a uniform rectangular mesh on the image under consideration. Any curvilinear grid may be used. Next, in stage 34, field variables are calculated at the various grid points using interpolation. In the next stage 36, the 3D continuous field may be represented by its value at the various grid points.

The continuous model may facilitate multi-resolution representation of the object. As the whole field is continuous, the shape of the object may be smoothed and the noise may be removed. The object may be represented at any resolution level.

A mean least square (MLS) interpolation scheme [as described in the paper by Lancaster P., and Salkauskas K., entitled Surfaces generated by moving least squares methods, Mathematics of Computation, 37:141-158, 1981] is preferably used to generate the global continuous model. The main advantages of MLS interpolation are that the approximated field function is continuous and smooth in the entire space and it is able to produce any order of consistency. This continuity and consistency will enable the continuous 3D model to be obtained from the set of isolated voxels 22.

The mathematical formulae used in one or more preferred embodiments of the invention are listed in Equations (1)-(7). More mathematical backgrounds can be found in the paper by Lancaster P., and Salkauskas K., entitled Surfaces generated by moving least squares methods, Mathematics of Computation, 37:141-158, 1981. For classic one-dimensional interpolation the generation formula is,

$$f ( w ) = {\sum }_{i = 1}^{n} {λ}_{i} ( w ) {u}_{i} where \{ \begin{matrix}{λ}_{i} ( {w}_{1} ) = 1 \\ {\sum }_{i = 1}^{n} {λ}_{i} ( w ) = 1 \\ {λ}_{i} ( w ) >= 0\end{matrix} \qquad ( 1 )$$

Factors λᵢ(w) are simply weights of control points uᵢ. One may define these factors in various ways, for example, weight may be defined as the inverse distance qᵢ(w) between a generic point and a control point uᵢ:

$${λ}_{i} ( w ) = \frac{{q}_{i} ( w )}{{\sum }_{i = 1}^{n} {q}_{i} ( w )} where , \\ {q}_{i} ( w ) = \frac{1}{{‖ w - {w}_{i} ‖}^{μ}} μ > 1 \qquad ( 2 )$$

For approximation in 3D space, the classic one-dimensional interpolation formula above is not applicable, instead, a set of basic functions of three variables is necessary. For linear interpolation, four basic functions of P(x) are sufficient:

P(x)=[1, x, y, z]^{τ} (3)

The above set of P(x) is a regular polynomial basic of the first order. According to the paper by Lancaster P., and Salkauskas K. entitled Surfaces generated by moving least squares methods, Mathematics of Computation, 37:141-158, 1981, an interpolation formula is constructed from the specific inner product of basic functions in control points. For N control points xⱼ in the neighbourhood of a generic point x, the approximation of a variable x uses the weight function Wⱼ(x):

$$\begin{matrix}{h}_{J} ( x ) = {W}_{j} ( x ) {P}^{τ} ( x ) {A}^{- 1} ( x ) P ( {x}_{j} ) & ( 4 ) \\ A ( x ) = {\sum }_{j = 1 , N} {W}_{j} ( x ) P ( {x}_{j} ) {P}^{τ} ( {x}_{j} ) & ( 5 ) \\ {W}_{j} ( x ) = \{ 1 - 6 {s}^{2} + 8 {s}^{3} - 3 {s}^{4} if 0 < s < 1 ; or 0 if s >= 1 \\ where , & ( 6 ) \\ s = ( x - {x}_{jo} ) / {r}_{j} & ( 7 )\end{matrix}$$

As in the one-dimensional case, the weight function is arbitrary and non-negative, and formula (6) above provides a monotonically decreasing function similar to a Gaussian, but less time for computing is required.

At a point (xc, yc, zc) in the continuous field, the tri-planar contour can be extracted from the continuous field. At each direction, the cross section plane in different directions is extracted, from which the contours are defined as the iso-contour of a threshold value in the plane.

For an exact definition, let u(x, y, z) be equipotential surface in our object, and u(x, y, z)=T₀ be a selected 3D contour (that is, surface). Therefore, contours on the axial, sagittal and coronal slices are:

C(_{c})={P(_{c}, y, z)u(x_{c}, y, z)=Tₒ}

C(y_{c})={P(x, y_{c}, z)u(x, y_{c}, z)=Tₒ}

C(z_{c})={P(x, y, z_{c})u(x, y, z_{c})=Tₒ} (8)

As the continuous model is represented by the value of the field variable at the grid points, interpolation is carried out to calculate a value between these grid nodes. For a 3D field, at any given point, it is possible to determine the cubic element in which this point is located. To address this point, an iso-parametric technique such as that described in the paper by Wang M, Shao M, entitled Fundamentals and numeric methods in finite element methods, TSing Hua University press, 1988, ISBN 7-302-00227-4 and shown in FIG. 4 may be used, the main steps of which are listed below. The advantage of iso-parametric interpolation is that it is simple and fast, and is able to generate smooth contours in any resolution.

With reference to the paper by Wang M, Shao M, entitled Fundamentals and numeric methods in finite element methods, TSing Hua University press, 1988, ISBN 7-302-00227-4, the definition of the transformation between global and local coordinate systems, which maps eight global nodes to the nodes of cubic with size 2*2*2* is as follows:

{x, y, z}^{τ}=f({ξ, η, ζ}^{τ}) (9)

This formula defines transformation of a point in coordinates (ξ, η, ζ) to new coordinate system (x, y, z). For isoparametric interpolation the set of approximated functions are expressed via three-linear basic functions Nᵢ.

$$\begin{matrix}x = {\sum }_{i = 1}^{m} {N}_{i} {x}_{i} , y = {\sum }_{i = 1}^{m} {N}_{i} {y}_{i} , z = {\sum }_{i = 1}^{m} {N}_{i} {z}_{i} \\ u ( x , y , z ) = {\sum }_{i = 1}^{m} {N}_{i} u ( {x}_{i} , {y}_{i} , {z}_{i} ) \\ {N}_{1} = ( 1 - ξ ) ( 1 - η ) ( 1 - ς ) / 8 \\ {N}_{2} = ( 1 + ξ ) ( 1 + η ) ( 1 + ς ) / 8 \\ {N}_{3} = ( 1 + ξ ) ( 1 + η ] ) ( 1 - ς ) / 8 \\ {N}_{4} = ( 1 - ξ ) ( 1 + η ) ( 1 - ς ) / 8 & ( 10 ) \\ {N}_{5} = ( 1 - ξ ) ( 1 - η ) ( 1 + ς ) / 8 \\ {N}_{6} = ( 1 + ξ ) ( 1 - η ) ( 1 + ς ) / 8 \\ {N}_{τ} = ( 1 + ξ ) ( 1 + η ) ( 1 + ς ) / 8 \\ {N}_{8} = ( 1 - ξ ) ( 1 + η ) ( 1 + ς ) / 8 & ( 11 )\end{matrix}$$

Expressions xᵢ, yᵢ, zᵢ stand for control points.

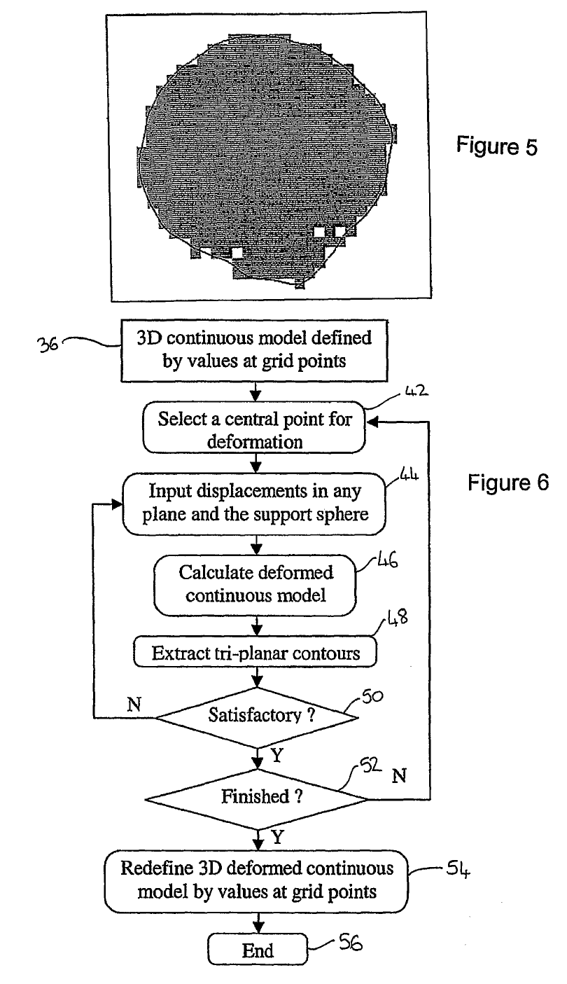

FIG. 5 shows a sample object. After constructing the continuous model, the contour may be extracted from such a field, as shown in FIG. 5. It should be noted that the noise which is present in the object region does not significantly affect the contouring result. Furthermore, the user may change the value of the threshold value to obtain the contour representing the smooth object boundary.

The continuous model and its contours in any direction may be obtained from the existing voxels. However, as these voxels come from image registration and preliminary segmentation, the result may not correspond accurately to the original dataset. The shape of the continuous model may be modified to enable it to fit to the object in the original dataset. Such a procedure is done through tri-planar contour editing. FIG. 6 shows the main steps of contour editing.

Taking as a starting point the continuous model 36 defined by values at the grid points, the contours obtained may be modified by shifting the positions of the grid points. The user may select, in the next stage 42, a central point for deformation near a contour point. In a further stage 44, the user may then displace the chosen point to a new position by, for example, dragging the selected point of the contour with a mouse, or using a keyboard. If the shape of the 3D model is to be deformed continuously, in a further stage 46, the position of grid points nearby must also be modified.

If the selected central point is X_{c}, the displacement for this point is ΔX_{c}, the displacement of any point X_{P} may be expressed as,

ΔX_{P}=W_{P}(X_{P})·ΔX_{c} (12)

where,

Wₚ(Xₚ)={1−6s²+8s³−3s⁴ if 0≦s≦1; or 0 if s>=1 (13)

s=(Xₚ−X_{Co})/r_{C} (14)

New tri-planar contours will need to be extracted to match the new outline. This is carried out in stage 48. A determination is then made in stage 50 as to whether or not the modification is satisfactory. If the modification is not satisfactory, then the user must return to the displacement stage 44 and repeat the process until satisfied. Once satisfied, the user must determine in stage 52 whether or not the process is to be ended. If the user wishes to continue the process, the user may then return to the selection stage 42 and select a new point for deformation, and repeat the process. Alternatively, when satisfied, the user may redefine, in a further stage 54, the 3D continuous model, by the values at the grid points, to include the changes made.

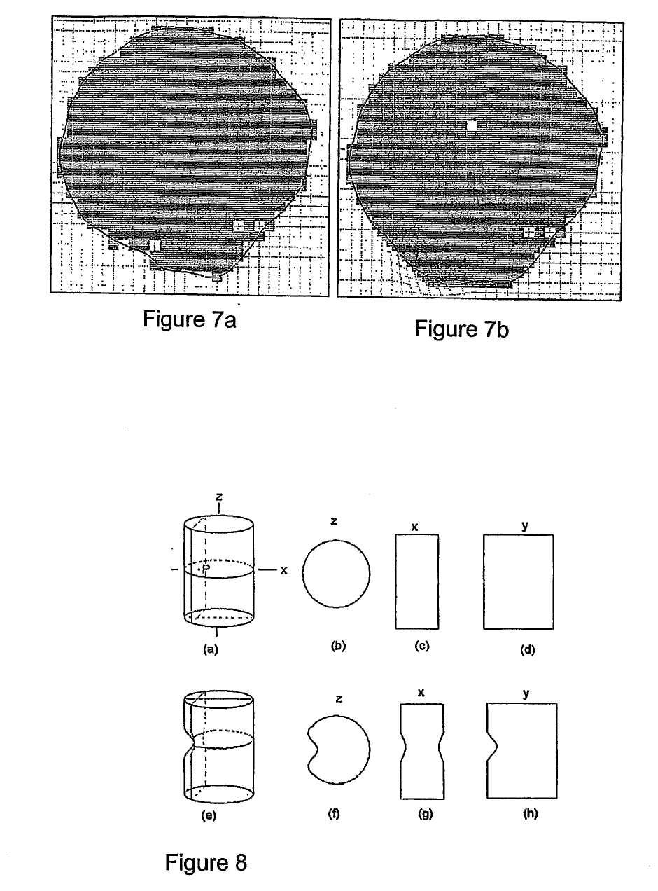

As the continuous 3D structure is deformed in a consistent way, the shape of the tri-planar contours will change consistently. It is therefore possible to approximate an object from a continuous model such as that shown in FIG. 7(a), by changing the position of the grids. FIG. 7(b) shows the approximated object generated in this manner.

Modification of the shape of the 3D continuous model causes the neighbouring regions also to be deformed according to the deformation defined by the user. As an example, FIGS. 8a to 8h illustrate the 3D result of tri-planar contour editing.

A cylinder shape shown in FIG. 8a is used as the input. The tri-planar contours are shown in FIGS. 8b to 8d. If the user selects point P, shifts this point P in the x direction guided by the contour of direction z, and deforms the shape of contour to that shown in FIG. 8e, the deformed 3D model and its contours in the other two directions are displayed in FIGS. 8f, 8g and 8h respectively. In this way, the complex 3D deformation of the 3D object is transformed to simple 2D manipulations of modification of a 2D contour. When the user is satisfied with the shape of the deformed object through examining and editing tri-planar contours at any point in the deformed object, the continuous model for the smooth continuous object may be generated.

With reference to formulae (10) and (11) above, constants xᵢ, yᵢ, zᵢ (i=1, . . . , 8) are given and are, in fact, the co-ordinates of the vertex I of the polytope domain of the volumetric image. Parameters ξ, η, ζ independently possess the values from a segment [−1, 1].

During modification of the image, continuous transformations and the specification of the boundary occur. These operations have varied constants xᵢ, yᵢ, zᵢ and modified parameters ξ, η, ζ. It is not generally possible to predict the transformation to be made. Therefore, the general parameters ξ, η, ζ are converted to new parameters α, β, γ by the vector function (α, β, γ)=G(ξ,η,ζ) and the constants xᵢ, yᵢ, zᵢ are reformed to uᵢ, vᵢ, wᵢ by a simple addition operation.

To provide one-to-one transformation, it is necessary to be certain of non-singularity of the Jacobian of transformation G [7,8]. This condition is ensured by feasible deformations of the image depicted in FIG. 4.

As a result of all of the transformations, a parametric representation of the converted image in the following form may be obtained:

$$\begin{matrix}u = {\sum }_{i = 1}^{8} {M}_{i} {u}_{i} , v = {\sum }_{i = 1}^{8} {M}_{i} {v}_{i} , w = {\sum }_{i = 1}^{8} {M}_{i} {w}_{i} , & ( 15 ) \\ {M}_{1} = ( 1 - α ) ( 1 - β ) ( 1 - γ ) / 8 \\ {M}_{2} = ( 1 + α ) ( 1 - β ) ( 1 - γ ) / 8 , \\ {M}_{3} = ( 1 + α ) ( 1 + β ) ( 1 - γ ) / 8 \\ {M}_{4} = ( 1 - α ) ( 1 + β ) ( 1 - γ ) / 8 , \\ {M}_{5} = ( 1 - α ) ( 1 - β ) ( 1 + γ ) / 8 \\ {M}_{6} = ( 1 + α ) ( 1 - β ) ( 1 + γ ) / 8 , \\ {M}_{7} = ( 1 + α ) ( 1 + β ) ( 1 + γ ) / 8 \\ {M}_{8} = ( 1 - α ) ( 1 + β ) ( 1 + γ ) / 8 , & ( 16 )\end{matrix}$$

where parameters α, β, γ vary in segment [−1, 1] independently.

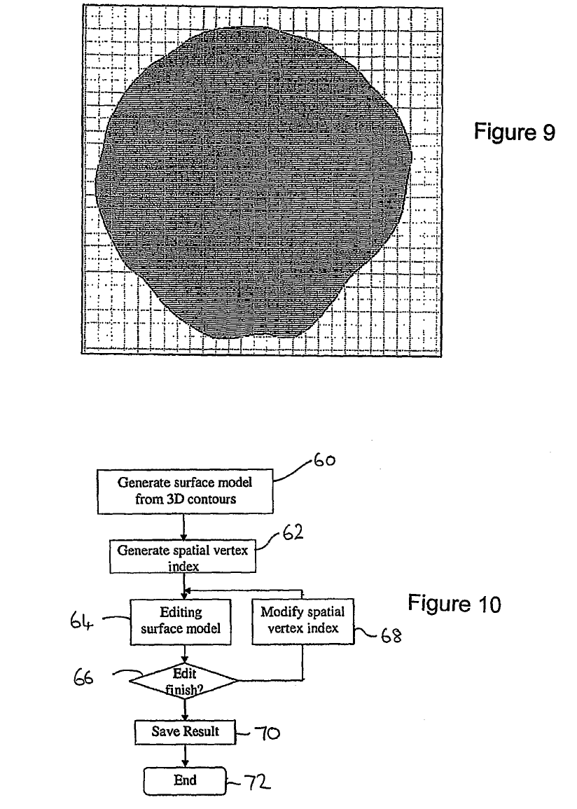

Due to the continuity of all of the functions u(α, β, γ), v(α, β, γ), w(α,β, γ), the boundary of the transformed image is smooth. FIG. 9 depicts the smoothed boundary of the object represented in FIG. 7(b).

The quantification of anatomical structures at sub-pixel or sub-voxel level is critical to many medical examinations. Due to the fact that a continuous model for the object is available in preferred embodiments of the present invention, the quantification of the model may be carried out accurately.

The problem of matching and registration of two 3D images is solved by applying an optimization technique. The mathematical model is based on the construction of a displacement field of the two volumetric images under comparison. The objective function consists of two items, namely the bending energy of the field, and the accuracy of the image transformation.

To formulate the model, if T(x) denotes a gradient field of displacement, and S depicts the 3D domain of the image, then the problem may be expressed as:

min→∫_{S}∥ΔT(x)∥²dx+∫_{S}∥T(x)−U(T(x))∥²dx, (17)

where, U(x) is an inverse transformation field.

Numerous conventional methods are known which attempt to solve equation (12) numerically [see for example the paper by Toga A. W., entitled Image Registration and the Construction Of Multidimensional Brain, In Handbook of medical imaging: processing and analysis I Ed. by 1. N. Bankman. San Diego, Calif.; London: Academic, 2000, pp. 569-603, and the paper by Johnson H. J. and Christensen G. E., entitled Consistent Landmark and Intensity-Based Image Registration IEEE Transactions On Medical Imaging, 21, No. 5, 2002.]. However, the exact analytical solution exists only in exceptional cases. The common approach is to apply procedures of approximation. In such an approach, a reasonable tolerance value must be selected to carry out the computation. One may apply a grid points algorithm to approximate the field function T(x). Monte-Carlo algorithms demonstrate fast convergence for this problem [see the paper by Sobol I. M. entitled A primer for the Monte Carlo method. Boca Raton: CRC Press, 1994].

The process of registration yields labelling for the structure of the object under consideration. The result of this processing may contribute to the construction of the atlas and is independent of the resolution of the scanning image, thus the process of mapping is simplified.

As the method embodying the present invention involves the continuous processing of the 3D model, the 3D atlas construction is facilitated.

Whilst the tri-planar contours for the 3D image model have been extracted, the surface model is much better and more suitable than the contours in presenting the 3D model visually, and virtual reality simulation applications.

Preferred embodiments of the present invention therefore provide an advanced technology to enable efficient manipulation of the surface model.

Reconstruction of a surface model from contours has been an active research area for more than twenty years. Research of 3D surface reconstruction from contours started from 1977 by Keppel [E. Keppel. Approximating complex surfaces by triangulation of contour lines. IBM Journal of Research and Development. 19. 1975. 2-11]. Since his method has been formalized and improved by many researchers, such as Fuchs [H. Fuchs, Z. M. Kedem, and S. P. Uselton, Optimal surface reconstruction from planar contours, Communications of the ACM. 20, 1977, 693-702], various methods and approaches have been initiated and conducted. In 1988, Boissionat [J. D. Boissonnat; Shape reconstruction from planar cross sections. Computer Vision, Graphics and Image Processing. 44. 1988. 1-29] presented a very different approach by introducing a Delaunay triangulation method for reconstruction of triangle mesh to generate the surfaces from contours. Meyers, Skinner, and Sloan [D. Meyers. S. Skinner, and K. Sloan. Surfaces from contours: The correspondence and branching problems, in Proceedings. Graphics Interface '91. 1991. pp. 246-254] explicitly divided the problem into four subproblems, namely the correspondence problem, the tiling problem, the branching problem, and the surface fitting problem.

The Euclidean distance field was used as an alternative approach to the calculation of an object from contour slices by Jones and Chen in 1994 [M. W. Jones and M. Chen, A new approach to the construction of surfaces from contour data, Computer Graphics Forum 13(3), 75-84, 1994]. This approach attempted to suggest a solution to resolve the traditional subproblems altogether. A surface reconstruction algorithm of piecewise-linear interpolation between polygonal slices was developed by Barequet and Sharir in 1996 [G. Barequet and M. Sharir, Piecewise-Linear Interpolation between Polygonal Slices, Computer Vision and Image Understanding, 63, 1996, 251-272]. Furthermore, Klein et al. [Reinhard Klein, Andreas Schilling, Wolfgang Strasser, Reconstruction and Simplification of Surfaces From Contours, Graphical models 1999] proposed a robust reconstruction algorithm using the distance field based on the medial axes, which also included a fast simplification algorithm. These methods have provided rational solutions for generating surface models from cross-planar contours, and therefore they will also be applicable to the generation of a surface from tri-planar contours.

Surface extraction directly from the image model is also the subject of much research. At present, fully automatic extraction of a surface model is still not mature enough for industry users. However, a semi-automatic extraction method, which can quickly identify the features of images with little user guidance, is becoming a useful and practical technology. Several methods have been adapted in this technology, such as Snake [Michael Kass, Andrew Witkin, Demetri Terzopoulos, Snakes: Active Contour Models, International Journal of Computer Vision, 1988, pages 321-331], Live-wire [E. N. Mortensen, B. S. Morse, W. A. Barrett, and J. K. Udupa, “Adaptive Boundary Detection Using ‘Live-Wire’ Two-Dimensional Dynamic Programming,” in IEEE Proceedings of Computers in Cardiology (CIC '92), pp. 635-638, Durham, N.C., October 1992]. In embodiments of the present invention, the implementation of live-wire user guidance surface extraction is useful to help users extract the surface directly from the 3D image models.

Surface models generated according to the conventional methods mentioned above are commonly stored in the form of a polygon mesh, or a list of polygon arrays, wherein the polygon consists a number of vertices. Due to the arbitrary nature of polygons, there is, in general, no generic principle to sort the vertices. Mostly, the vertices are conventionally stored in a computer in an array as they were generated, and a polygon index is used to indicate their connections. Thus, the spatial information of the vertices of polygonal surfaces is not sorted in any order in conventional systems. In view of this, when the spatial position of a vertex is required, for example, in the pick up and manipulation of vertices on the surface in 3D scenes, in conventional systems a program must search through all the vertices to determine the vertices that will be used.

In real applications, the number of vertices in geometrical shapes and surfaces tend to be large, for example, from around one thousand to tens or even hundreds of thousands. If a scenario requires frequently acquiring vertices based on spatial information, such as interactive surface editing, local deformation of surfaces, or collision detection, or FEM calculation, or the like, then the computational task is very heavy, and this will directly affect the system performance.

As discussed above, the surface model is generated from 3D contours. As shown in FIG. 10, the first stage is to generate the surface model from 3D contours. From this model, a spatial vertex index is generated in stage 62. It is then possible to edit the surface model to obtain the desired shape. After editing, a decision to continue editing or to finish must be made. Should it be necessary to continue, the spatial vertex index will need to be modified 68. The process continues until a satisfactory result has been obtained, at which stage 70 the result is saved and the process discontinued 72.

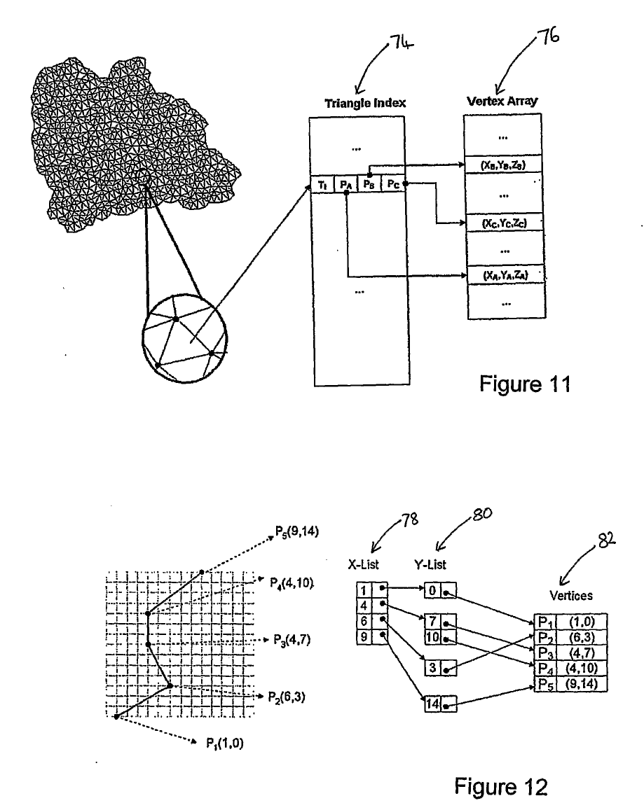

FIG. 11 shows a conventional triangle surface data storage and index system where vertices are stored in an unstructured style. The triangle index 74 is built up for rendering purposes, but it does not help in spatial retrieval. This is achieved from the vertex array 76 which is assembled from the triangle index 74 but is in no particular order and is stored as the data is received.

To overcome or ameliorate the problems with traditional methods, an embodiment of the invention proposes a method of indexing the spatial information for surface manipulation in interactive computer graphics. The index method uses fundamental data structures and algorithms similar to those used in sparse matrix computing [Zahari Zlatev, Computational Methods for General Sparse Matrices, Kluwer Academic Publishers, 1991].

The spatial information is stored in a list-type of data structures. The data structures have pointers pointing to a list or array, where the unstructured vertices data are stored.

The data structure used is variable, for example, it may be a linked list, a linked table or the like. The choice of the data structure is dependent on the application requirements and the system resources.

The method of indexing, as shown in FIG. 12, is as follows:

Firstly, the spatial scope of interest is defined using a uniform grid cell structure. Next, a three layer linked data structure is created, the layers representing the x, y, z, coordinates of space. The order is not of importance at this stage and it can vary if applications require. The next stage is to scan all of the vertices once and, for each vertex, to calculate the index number of the cell in which the vertex falls. If the node for this cell exists in the spatial index structure, the vertex index is then added into the node. If the node for this cell does not exist, the node is created and inserted into the proper position of the spatial index structure, and the vertex is added into the node.

In this example, a 2D illustration is given to interpret the algorithm. However, a 3D grid is a projected 2D grid and the polygon surface is projected to line segments.

In the system of FIG. 12, an array list is used to store vertex data, however, many other data structures may also be used, such as a linked list, and/or a B-tree. Data structure suitable for building this index maybe found in Donald Knuth, The Art of Computer Programming, Vol. 1, Fundamental Algorithms, Addison-Wesley, 1997 and Robert L. Kruse, Programming with Data Structures, Prentice Hall, 1989. The choice of data structure used will depend on the specific application and the user's choice.

From FIG. 12, it is possible to explain how to retrieve a vertex using the spatial index structure according to an embodiment of the invention. Given a position in space, for example Q(x1, y1, z1), the application will travel through the X-list first, if there is no node representing x1, then there is no such vertex in the polygon surface. If an x1 node exists, the application will follow the link to check the corresponding Y-list. If there is no y1 node list in existence in the Y-List, then again there is no vertex at the Q position. If there is a y1 node in the Y-List, the corresponding Z-List will be checked. If there is a vertex near enough to Q, a z1 node in the Z-list will be found and a pointer pointing to the right vertex.

Here, the ‘vertex exists’ should be taken to mean “close enough to fall in the grid cell”. This is de facto in floating number computation and in computer graphics. It is not necessary to adhere to any unit of measurement in consideration of the cell size. The size of the grid cell may be determined by the users based on their usage and resources.

The size of the grid cell can also be used to control the resources used by the indexing data structure.

In some applications, it may be necessary to retrieve not just a single vertex, but, for example, a region, or a vertex as a centre and its neighbourhood vertices. The enquiry may be defined as a bounding box that is equivalent to the size of the region of interest. When retrieved by a bounding box, the algorithm will take the bounding plane of the bounding box in each dimension as an interval, and then compare the grid cells within the interval. This retrieval will return a bunch of neighbourhood vertices as requested.

In some applications, the spatial position of the vertices may be changed during the operation of the application. In this case, the spatial index may also be affected. To ensure the index is correct, the vertex coordinates need to be verified. If the vertex still falls in the grid cell, then nothing needs to be changed. If the vertex falls in another grid cell, then the index to the vertex will be removed from the current cell node, and added into the cell node corresponding to the new position.

It is clear from the above that the performance response in preferred embodiments of the invention to retrieving a vertex by spatial enquiry is significantly improved over conventional systems.

For example, if a geometry shape segmented from a one hundred cube image volume is considered, such a shape has around ten thousand vertices which form more than twenty thousand triangles. In order to check a vertex is at a certain position, a conventional program would need to browse through all the vertices. On average, it will need to check five thousand vertices.

However, in the spatial index structure according to an embodiment of the invention, taking a pixel cube as the grid cell, then the maximum length of the linked list is one hundred, (in fact, it is much less, on average, in a real scenario). Therefore, if the vertex exists, on average the computation will be only 50(for X-list)+50(for Y-list)+50(for Z-List). That is, the average comparison computing time is only 150. This is a dramatic improvement compared to five thousand comparisons in traditional retrieval. The speed of retrieval may be improved by more than 90 percent, which is particularly advantageous.

Certain overhead resources are needed to maintain the spatial index. However, if the implementation of applications using this method can be carefully designed, the resource can be minimized compared to the resource used by the geometrical surface itself. Considering the index structure only needs to present grid cells containing vertices, the number of nodes in the index structure should be something similar to the number of the vertices. However, the data stored in the index node are all integers which may be represented by 1 or 2 bytes. In the above example, the pointers in the index structure only need to have the maximum value 100, which can be represented by 1 byte. In summary, the total memory used by the structure, is about the same order of bytes as is used by a pointer, times the number of vertices.

By contrast, the polygonal vertices are typically represented by a floating number, which, in a preferred embodiment, is a minimum of 4 bytes of data. In such an embodiment, each vertex will need three floating numbers for co-ordinate values and, sometimes, three floating numbers for normal values. More floating numbers may be required for other information such as rendering. Hence, in such an embodiment, a vertex will need at least six floating numbers for rendering purposes. Six floating numbers needs at least 24 bytes. Therefore, in the example mentioned above, a polygon surface having ten thousand vertices will need at least 240K of memory. Furthermore, the triangle index will require around 200K as it has twenty thousand triangles. Thus, in this example, the total memory used for rendering will be up to 500K. This means that the overhead memory used by the spatial index structure will only take about 10 to 20% of the total memory used by the polygon surface. Considering the dramatic performance improvement, this is an acceptable trade-off.

Another factor which may be justified is the grid cell size. Increasing the size of the grid cell will reduce the precision of enquiry, and a grid cell may contain more vertices. However, the index structure will become smaller which will reduce the overhead resources used. The user may vary these factors to obtain the desired balance between performance and the resource used.

In summary, embodiments of the invention provide a convenient tool for users to extract the shape of an object. As mentioned above, there exists in conventional methods and systems the major problem of the vertices of the polygon surfaces being stored in an unstructured order which causes problems in retrieving vertices using spatial information. This is a common problem in interactive graphics applications, such as surface editing and deformation. Embodiments of the invention enable the building of a spatial index of vertices for polygon surfaces, and provide means such as algorithms for accessing vertices and their neighbourhood using spatial information.

Embodiments of the invention may be broadly used in many application domains, such as computer graphics, visual simulation systems, virtual reality systems, geometrical model editing applications and FEM computation, to name but a few. In particular, it is considered that embodiments of the invention may find applications in, for example, the fields of radiology, such as in diagnostic radiology imaging, medical imaging and medical image processing, interactive image editing, tissue volume segmentation, quantitative imaging, anatomical segmentation, surface model visualization and editing, interactive visual simulation, three dimensional modelling, extramedical image processing, computer gaming, map feature recognition, geometric modeling, interactive visualization, and surgery planning and simulation.

It is further considered that embodiments of the invention may be particularly useful in the fields of medical research for segmentation of medical data, such as VHD or radiological images, medical research for construction of human body models, such as a brain atlas, or orbit atlas, radiology and surgery for accurate 3D segmentation and quantification of tumours and radiotherapy for accurate 3D planning of doses.

It will be appreciated that the scope of the present invention is not restricted to the described embodiments. Numerous other modifications, changes, variations, substitutions and equivalents will therefore occur to those skilled in the art without departing from the spirit and scope of the present invention.

1. A method for editing three dimensional images, the method comprising the steps of:
obtaining three dimensional data representative of an image;
segmenting the data to select data to be processed;
generating a three dimensional model of the selected data;
interpolating the three dimensional model of the selected data to generate a continuous three dimensional model;
extracting one or more tri-planar contours from the continuous three dimensional model;
editing the continuous three dimensional model;
generating a three dimensional surface model from the one or more extracted tri-planar contours; and
editing the three dimensional surface model.

2. The method of claim 1, wherein the step of segmenting comprises:
applying an interactive segmentation process.

3. The method of claim 2, wherein the interactive segmentation process comprises an automatic algorithm for obtaining the three dimensional data corresponding to the selected data to be processed.

4. The method of claim 2, wherein the interactive segmentation process comprises a semi-automatic algorithm for obtaining the three dimensional data corresponding to the selected data to be processed.

5. The method of claim 2, wherein the interactive segmentation process comprises an interactive algorithm for obtaining the three dimensional data corresponding to the selected data to be processed.

6. The method of claim 2, wherein the step of segmenting further comprises the step of generating a pattern of voxels representing the image being examined.

7. The method of claim 1, wherein the step of segmenting comprises:
selecting from a stored model and/or a stored atlas data representative of the data to be processed;
warping the data representative of the data to be processed to match approximately the three dimensional data representative of the image; and
generating a pattern of voxels representing the image being examined.

8. The method of claim 1, wherein the selected data corresponds to a three-dimensional volume and wherein the step of generating the three dimensional model of the selected data comprises:
determining the three-dimensional volume corresponding to the selected data;
determining grid points in the three dimensional volume; and
calculating by means of interpolation the one or more field variables at said grid points to provide a three-dimensional continuous field defined by the one or more field variables at said grid points to generate the continuous three dimensional model.

9. The method of claim 1, wherein the continuous three dimensional model is defined by one or more values at grid points, and wherein the step of editing the continuous three dimensional model comprises:
adjusting the one or more extracted tri-planar contours; and
shifting one or more positions of the one or more grid points to alter the shape of the continuous three dimensional model.

10. The method of claim 1, wherein the step of generating a three dimensional surface model comprises:
generating a spatial vertex index for the surface model, the spatial vertex index comprising a list of x coordinates, a list of y coordinates and a list of z coordinates; and
storing the spatial vertex, wherein the list of x coordinates, the list of y coordinates and the list of z coordinates are stored separately.

11. The method of claim 10, wherein the step of editing the three dimensional surface model comprises, for a given point having an associated x co-ordinate and an associated y co-ordinate, determining if the x co-ordinate for the given point is stored in the spatial vertex index and, if so, determining if the corresponding y co-ordinate is also stored in the spatial vertex index and, if so, editing the three dimensional surface model by altering the x and/or y and/or z co-ordinates.

12. The method of claim 11, further comprising storing the edited three dimensional surface model.

13. The method of claim, wherein one or more of the steps are implemented in software and/or hardware.

14. An apparatus for editing three dimensional images comprised of three dimensional image data, the apparatus comprising:
a selector for segmenting the data to select data to be processed;
a first generator for generating a three dimensional model of the selected data;
an interpolator for interpolating the three dimensional model of the selected data to generate a continuous three dimensional model;
an extractor for extracting one or more tri-planar contours from the continuous three dimensional model;
a first editor for editing the continuous three dimensional model;
a second generator for generating a three dimensional surface model from the one or more extracted-tri-planar contours; and
a second editor for editing the three dimensional surface model.

15. The apparatus of claim 14, wherein the selector is arranged to apply an interactive segmentation process.

16. The apparatus of claim 15, wherein the interactive segmentation process comprises an automatic algorithm for obtaining the three dimensional data corresponding to the selected data to be processed.

17. The apparatus of claim 15, wherein the interactive segmentation process comprises a semi-automatic algorithm for obtaining the three dimensional data corresponding to the selected data to be processed.

18. The apparatus of claim 15, wherein the interactive segmentation process comprises an interactive algorithm for obtaining the three dimensional data corresponding to the selected data to be processed.

19. The apparatus of claim 15, wherein the selector is arranged to generate a pattern of voxels representing the image being examined.

20. The apparatus of claim 14, wherein the selector comprises:
means for selecting from a stored model and/or a stored atlas data representative of the data to be processed;
means for warping the data representative of the data to be processed to match approximately the three dimensional data representative of the image; and
means for generating a pattern of voxels representing the image being examined.

21. The apparatus of claim 14, wherein the selected data corresponds to a three-dimensional volume and wherein the first generator is arranged to determine the three-dimensional volume corresponding to the selected data, to determine grid points in the three dimensional volume, and to calculate by means of interpolation one or more field variables at said grid points to provide a three-dimensional continuous field defined by the one or more field variables at said grid points to generate the continuous three dimensional model.

22. The apparatus of claim 14, wherein the continuous three dimensional model is defined by one or more values at one or more grid points, and wherein the first editor is arranged to adjust the one or more extracted tri-planar contours, and to shift one or more positions of the one or more grid points to alter the shape of the continuous three dimensional model.

23. The apparatus of claim 14, wherein the second generator is arranged to generate a spatial vertex index for the surface model, the spatial vertex index comprising a list of x co-ordinates, a list of y co-ordinates and a list of z coordinates; and wherein the apparatus further comprises a memory store for storing the spatial vertex, wherein the list of x co-ordinates, the list of y coordinates and the list of z coordinates are stored separately.

24. The apparatus of claim 23, wherein the second editor is arranged, for a given point having an associated x co-ordinate, an associated y co-ordinate and an associated z coordinate, to determine if the x co-ordinate for the given point is stored in the spatial vertex index and, if so, to determine if the corresponding y co-ordinate is also stored in the spatial vertex index and, if so, to determine if the corresponding z coordinate is also stored in the spatial vertex index and, if so, to edit the three dimensional surface model by altering the x and/or y co-ordinates and/or z coordinates.

25. The apparatus of claim 24, further comprising a memory store for storing the edited three dimensional surface model.

26. The apparatus of claim 14, wherein one or more of the selector, first generator, interpolator, extractor, first editor, second generator and second editor are implemented in software and/or hardware.

27. A computer program product comprising:
a computer usable medium having a computer readable code and computer readable system code embodied on said medium for editing three dimensional images; said computer program product further comprising:
computer readable code within said computer usable medium for:
obtaining three dimensional data representative of an image;
segmenting the data to select data to be processed;
generating a three dimensional model of the selected data;
interpolating the three dimensional model of the selected data to generate a continuous three dimensional model;
extracting one or more tri-planar contours from the continuous three dimensional model;
editing the continuous three dimensional model;
generating a three dimensional surface model from the one or more extracted tri-planar contours; and
editing the three dimensional surface model.
